(19) United States
(12) Patent Application Publication
(10) Pub. No.: US 2010/0122993 A1
(43) Pub. Date: May 20, 2010

(54) Pocket supported dispenser OFR dispensing disinfecting fluid

(76) Inventors: Kelly James Tenbrink, Cincinnati, OH (US); Christopher Kinsella, Pittsburgh, PA (US)

Correspondence Address: FLOYD B. CAROTHERS;CAROTHERS AND CAROTHERS, 445 FORT PITT BOULEVARD, SUITE 200, PITTSBURGH, PA, 15219, US

(21) Appl. No.: 12/590,347

(22) Filed: Nov. 5, 2009

Related U.S. Application Data
(60) Provisional application No. 61/115,373, filed on Nov. 17, 2008.

(51) Int. Cl. B05B 11/00; A45F 5/02

(52) U.S. Cl. 222/175; 222/321.9

(57) ABSTRACT

A pocket supported dispenser for dispensing small amounts of disinfecting fluid from a container holding the disinfecting fluid is provided with a pump spray head secured to an upper end thereof for dispensing small amounts of fluid from the container through a nozzle of the spray head. The container is supported from a pocket support that is contoured and dimensioned for supporting the container from the bottom interior of a pocket, such as the side pocket of a lab coat, leaving the pump spray head exposed above a top edge of the pocket for downward hand pumping compressions of the pump spray head to dispense fluid through the nozzle. The support for the container includes a lip protruding outwardly over an upper edge of the pocket and extends in the same direction of the spray emanating from the pump spray nozzle off to a forward side of the pocket for engagement by the operator's fingers.

### CROSS-REFERENCE

This application claims the benefit of U.S. Provisional Application No. 61/115,373, filed Nov. 17, 2008, the contents of which are incorporated herein by reference in their entirety.

### BACKGROUND OF THE INVENTION

The present invention pertains to a dispenser for dispensing a small amount of disinfecting fluid, such as, alcohol gel hand rub, for use by physicians and nurses during their normal activities, which dispenser is carried on the person.

On average, six million people die each year due to infections acquired at the hospital. In the medical field hand sanitization and combating the spread of infection within a hospital is a matter of life and death. To deal with this, medical facilities have installed hand sanitizer dispensers on walls and counters in an attempt to make it convenient for medical staff to frequently sanitize their hands. It has been proven time and time again that these units are not used nearly as frequently as they should.

A number of wearable dispensing devices have been designed for speed and ease of repeated use for dispensing disinfecting fluids. For example, see US Patent Application Publication Nos. 2006/0289567 published Dec. 28, 2006, and US 2007/00517752 published Mar. 8, 2007, and U.S. Pat. Nos. 5,927,548 issued Jul. 27, 1999, and 6,983,864 issued Jan. 10, 2006.

Problems with such existing wearable dispensing devices is that they are designed to be carried by a belt or they are clipped onto a pocket. Medical staff rarely use belts as belts, and waistbands of pants act as a collector of contaminants, and belts are difficult to cleanse. Accordingly, sanitary washable garments without belts or waistbands are worn. In addition, the pocket supported dispensers cannot be readily operated effectively and conveniently while clipped on to the pocket, and if utilized while clipped to a pocket, they exert excessive stress onto the lip and seams of the pocket, and deform the pocket whereby the dispenser slides around in the pocket and it is difficult to manipulate and operate the dispenser as stored in or on the pocket.

It is a principal object of the present invention to eliminate these aforesaid problems.

### SUMMARY OF THE INVENTION

The present invention provides a pocket supported dispenser for dispensing small amounts of disinfecting fluid, such as, an alcohol-glycerine disinfecting gel or liquid, from a container which includes an interior for holding the disinfecting fluid. A pump spray head is secured to an upper end of the container for dispensing small amounts of fluid from the container through a nozzle on the spray head. Full support by the pocket is provided by a pocket support that is contoured and dimensioned for supporting the container from the bottom interior of the pocket with the pump spray head exposed above the top edge of the pocket for downward hand pumping compressions of the pump spray head to dispense fluids through the nozzle without displacing the dispenser in the pocket and without distorting the pocket.

The pump spray head is positioned at a side edge of the pocket with a nozzle directed to spray to the side of the pocket. This permits the physician or nurse to carry the dispenser of the present invention in the side pocket of a lab coat, which physicians and nurses commonly wear, and thereby conveniently reach and pump fluid in a forward direction into one's hand.

The pocket support consists of a bracket supporting the container wherein the bracket follows bottom contours of the pocket and extends upward to support the container in an upright position with the pump spray head exposed above the pocket. This bracket also preferably includes a lip protruding outwardly over an upper edge of the pocket and extending in the same direction as the directional spray emanating from the spray nozzle. This protruding lip is positioned below the spray head, and also positioned relative to the spray head, whereby the lip may be grasped by the fingers of the operator's hand for leveraged downward pump compressions of the pump spray head with the palm of the operator's hand to dispense disinfecting fluid on the operator's hand. The dispenser of the present invention accordingly provides complete and full support of the dispenser for actual convenient operation thereof in the lab coat pocket as the container is fully supported in the pocket for downward pump compressions on the spray head and the spray head is faced to the side of the pocket or forward relative to the operator's lab coat for convenient dispensing.

The support bracket may also include a downwardly depending finger that extends externally of the pocket and downwardly from the protruding lip. This provides additional support for the support bracket to assist in preventing the support bracket from displacing within the pocket when hand pump compressions are applied to the spray head.

The pocket support itself, instead of being in the form of an elongated bracket, may in fact be comprised of the fluid container itself whereby the fluid container is shaped in dimension to fully fit and fill the interior contours of the pocket whereby the dispenser is fully supported within the lab coat pocket for well supported and convenient operation of the pump spray head.

### BRIEF DESCRIPTION OF THE DRAWINGS

Other objects and advantages appear hereinafter in the following description and claims. The accompanying drawings show, for the purpose of exemplification, without limiting the scope of the present invention or the appended claims, certain practical embodiments of the present invention wherein:

FIG. 1 is a view in side elevation of a first embodiment of the dispenser of the present invention with the dispenser container shown in partial section and as supported in a lab coat side pocket during operation;

FIG. 2 is a view in side elevation of a second embodiment of the dispenser of the present invention illustrated as being supported within the side pocket of a lab coat;

FIG. 3 is a top view of the dispenser illustrated in FIG. 2;

FIG. 4 is a perspective view from the back side of the dispenser illustrated in FIGS. 2 and 3;

FIG. 5 is a right end view in front elevation of the dispenser illustrated in FIGS. 2 and 3;

FIG. 6 is a top view of the dispenser illustrated in FIG. 2 with the dispenser container or bottle and its associated spray pump removed;

FIG. 7 is a back side view in side elevation of the dispenser illustrated in FIGS. 2, 3, 4 and 5 with the container support illustrated in mid cross section and the container also illustrated in partial mid cross section as seen along section line VII-VII of FIG. 5;

FIG. 8 is a view in side elevation of a third embodiment of the dispenser of the present invention providing full support in a lab coat side pocket; and

FIG. 9 is a top view of the embodiment illustrated in FIG. 8.

### DETAILED DESCRIPTION OF THE PREFERRED EMBODIMENT

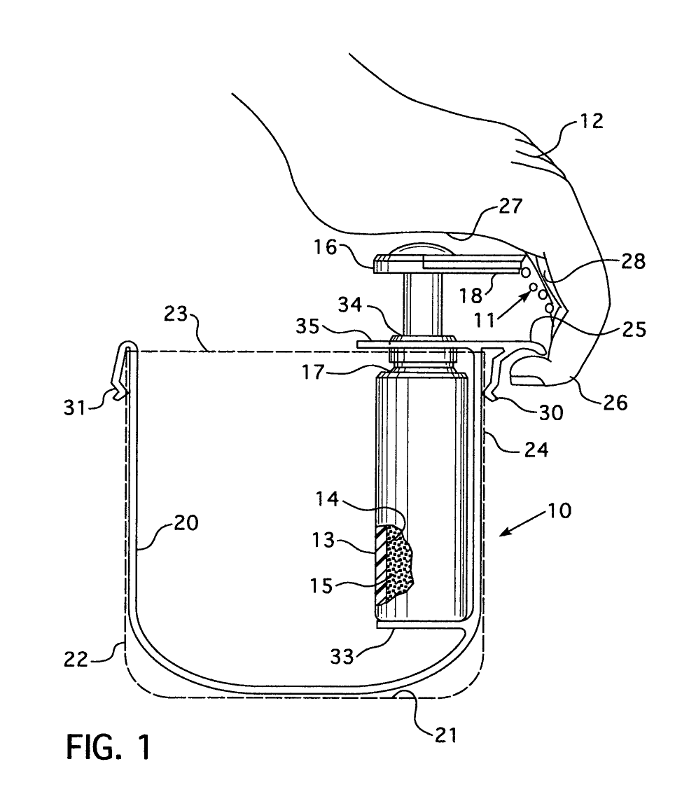

Referring first to the embodiment illustrated in FIG. 1, the pocket supported dispenser 10 of the present invention is provided for dispensing small amounts 11 of disinfecting fluid 15, such as an alcohol based gel, into the hand 12 of an operator, such as a physician or nurse. The dispenser 10 includes a cylindrical bottle or container 13 with interior 14 for containing disinfecting fluid 15.

A pump spray head 16 is secured to an upper end 17 of container 13 for dispensing small amounts of fluid 15 as indicated at 11 through nozzle 18 of spray head 16.

Pocket support 20 supports container 13 and is contoured and dimensioned for supporting container 13 from the bottom interior 21 inside lab coat pocket 22 illustrated in dashed outline. The container 13 is thus supported with spray head 16 exposed above the top edge 23 of pocket 22 for downward hand pumping compressions of pump spray head 16 to dispense the disinfecting fluid 15 through nozzle 18 as illustrated by the fluid spray 11.

The spray head 16 is positioned at side edge 24 of pocket 22 with the nozzle 18 directed to spray as indicated at 11 in the forward direction to the side 24 of pocket 22. This provides a convenient location for the user.

The dispenser 10 is accordingly supported from the bottom contours 21 of side lab coat pocket 22 and therefore remains in position even though pumping applications are being applied to spray head 16. Also, no undo stress is applied to the upper pocket edge 23 or to the side seams of pocket 22. In addition, the configuration of the dispenser 10 of the present invention prevents the dispenser from shifting position within pocket 22 and the dispenser 10 accordingly remains with solid support during pumping operations. Bracket 20 follows the bottom contours 21 of pocket 22 and extends upwardly to support container 13 in the upright position as illustrated with the pump spray head exposed above the upper edge 23 of pocket 22.

Bracket 20 further includes a lip 25 protruding outwardly in a forward direction over the upper edge 23 of pocket 22. Lip 25 extends in the same direction as the direction of spray 11 emanating from nozzle 18 and is positioned below spray head 16, and relative thereto, whereby lip 25 may be grasped by the fingers 26 on operator's hand as illustrated in the figure for leverage downward pump compressions of pump spray head 16 with the palm 27 of the operator's hand to dispense disinfecting fluid 15 on the inside 28 of the operator's hand. After dispensing of the disinfecting fluid as illustrated, the operator then rubs his or her hands together uniformly spreading the disinfecting fluid over all portions of the hands in a conventional manner to adequately disinfect the hands before contacting a patient or an implement which will contact the patient.

To further insure the solid support of bracket 20 within pocket 22, a downwardly depending finger 30 extends externally of pocket 22 from lip 25. This downwardly depending finger 30 assists in preventing the bracket 20 from slipping downwardly into or around in the interior of pocket 22. A similar downwardly depending finger 31 is provided on the opposite end of bracket 20.

Container 13 is in the form of a plastic cylindrical bottle and it is supported on bracket 20 at the bottom by bottom arm support 33. Container 13 is supported at the top by a clip engagement adjacent screw cap 34 with a snap fit in an opening contained in upper support arm 35. This connection will be explained in greater detail with regard to the next embodiment.

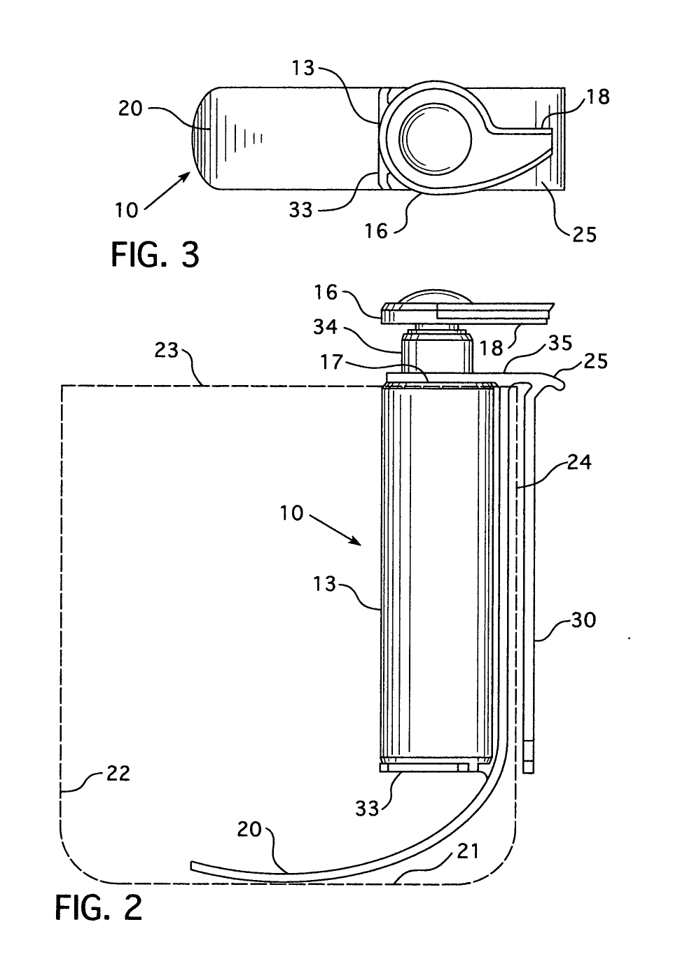

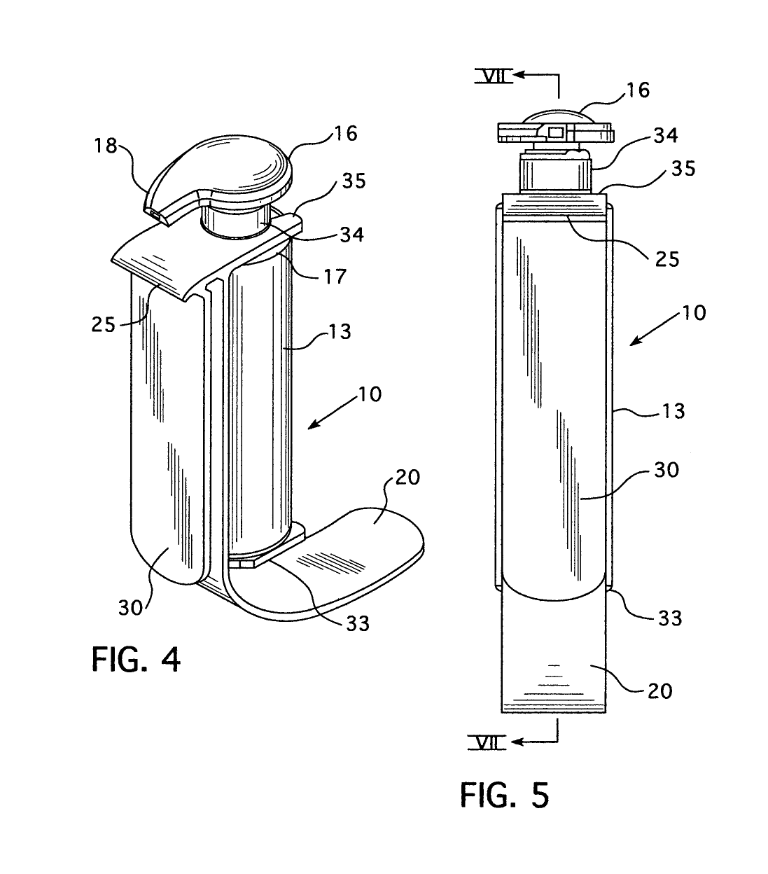

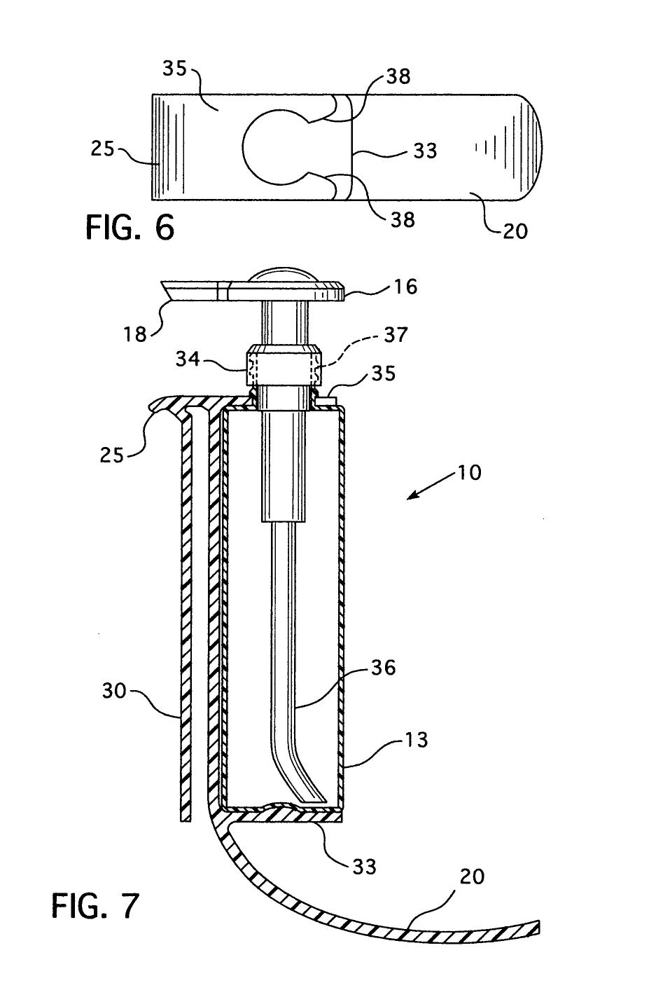

Turning next to the embodiment illustrated in FIGS. 2 through 7, similar elements are designated with the same reference numerals.

The primary difference between the embodiment illustrated in FIGS. 3 through 7, from that illustrated in FIG. 1, is that the bracket 20 is much shorter in length, yet is contacted with and is fully supported by the bottom interior contours 21 of pocket 22. In addition, the downwardly depending finger 30 is made considerably longer to further ensure that the shortened bracket 20 does not slide downwardly into and rearwardly around the interior of pocket 22.

FIG. 7 further illustrates the manner in which container 13 is supported on bracket 20 and further discloses the interior of container 13.

As illustrated in FIG. 7, the container 13 and spray head 16 are conventional in function and design. When the top of hand spray head 16 is compressed downwardly against the compression of an internal spring (not shown) a small quantity of the fluid 15 is pumped upwardly through tube 36 and out nozzle 18 as indicated in the form of a spray 11 in FIG. 1.

The upper neck 37 is engaged between the flexible fingers 38 of support arm 35 and there further retained by the contact of screw on cap 35.

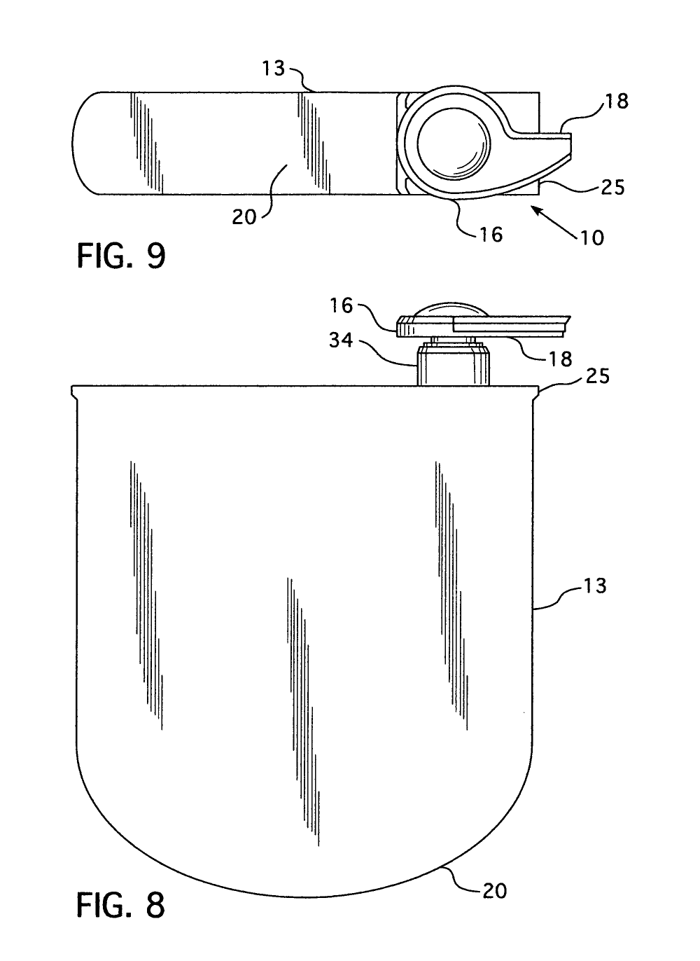

Turning next to the embodiment illustrated in FIGS. 8 and 9, the dispenser 10 is contoured and configured whereby container 13 is in and of itself shaped and dimensioned to provide the pocket support 20 to thereby fully contact the bottom and inside interior edges of pocket 22 thereby eliminating the requirement of an external downwardly depending finger 30 and separate container and support elements 13 and 20.

I claim:

1. A pocket supported dispenser for dispensing small amounts of a disinfecting fluid, comprising:
a container including an interior for holding a fluid;
a pump spray head secured to an upper end of said container for dispensing small amounts of fluid from said container through a nozzle of the spray head;
a pocket support contoured and dimensioned for supporting said container from the bottom interior of a pocket with said pump spray head exposed above a top edge of the pocket for downward hand pumping compressions of said pump spray head to dispense fluid through said nozzle.

2. The pocket supported dispenser of claim 1, said pump spray head positioned at a side edge of said pocket with said nozzle directed to spray to the side of said pocket.

3. The pocket supported dispenser of claim 2, said pocket support consisting of a bracket supporting said container, said bracket following bottom contours of said pocket and extending upward to support said container in an upright position with said pump spray head exposed above said pocket.

4. The pocket supported dispenser of claim 3, said bracket including a lip protruding outwardly over an upper edge of said pocket and extending in the same direction as the direction of spray emanating from said nozzle, and positioned below said spray head and relative thereto whereby said lip may be grasped by the fingers of an operator's hand for leveraged downward pump compressions of said pump spray head with the palm of an operator's hand to dispense disinfecting fluid on to the operator's hand.

5. The pocket supported dispenser of claim 4, said bracket including a downwardly depending finger extending externally of said pocket from said lip.

6. The pocket supported dispenser of claim 1, wherein said pocket support is comprised of said container shaped and dimensioned to fit and fill the internal contours of said pocket.
